(19) United States
(12) Patent Application Publication
(10) Pub. No.: US 2021/0216900 A1
(43) Pub. Date: Jul. 15, 2021

(54) ESTIMATING AN ENERGY LEVEL OF A PHYSICAL SYSTEM

(71) Applicant: River Lane Research Ltd., Cambridge (GB)

(72) Inventors: Oscar HIGGOTT, Cambridge (GB); Daochen WANG, Cambridge (GB)

(21) Appl. No.: 17/250,060

(22) PCT Filed: May 16, 2019
(86) PCT No.: PCT/GB2019/051345

§ 371 Date: Nov. 16, 2020

(30) Foreign Application Priority Data
May 16, 2018 (GB) 1807973.1

(51) Int. Cl. G06N 10/00; G06F 11/34

(52) U.S. Cl. CPC G06N 10/00; G06F 11/3409

(57) ABSTRACT

A method comprises performing an iterative optimisation procedure. Each iteration of the optimisation procedure comprises: preparing a first ansatz trial state using a first arrangement of quantum gates, the first ansatz trial state having a first state energy which is dependent on a trial state variable; performing an energy estimation routine to determine and output a value associated with an estimate for the first ansatz trial state energy; performing an overlap estimation routine to determine and output a degree of overlap between a first prepared state corresponding with or based on the first ansatz trial state, and a second prepared state corresponding with or based on a known state; determining the value of an optimisation function based on the outputs of the energy estimation routine and the overlap estimation routine; and updating the trial state variable.

This disclosure relates to determining an energy level, and in particular relates to a method for determining an unknown energy level of a physical system using a quantum computer.

### BACKGROUND

It is extremely useful in many areas of technology to be able to determine the possible eigenstates and energies of a physical system such as a molecule or atom. Determining how the energy is likely to change as the system is perturbed allows many molecular properties to be derived. For example, by solving the Schrödinger equation associated with the molecular electronic structure Hamiltonian for a number of nuclear geometries, it is possible to construct the potential energy surface (PES) of a molecular system. Knowledge of the PES is hugely important, particularly in the field of chemistry, as it allows scientists to determine, among other things, rates of reactions.

Determining excited states is required to determine optical spectra, as well as other charge and energy transfer processes in photovoltaic materials. Characterisation of excited states also allows a better understanding of many chemical reactions, such as those that involve photodissociation. Moreover, classical methods such as density functional theory are often unable to determine excited states, even for materials where ground state energy calculations are possible.

Many current methods of obtaining information about the eigenstates and energies of physical systems rely on classical computers, which use complicated algorithms to simulate the physical system. However, such methods often require an unmanageable amount of computing resources or do not return solutions to sufficient accuracy. It is possible to simulate systems much more efficiently on a quantum computer than is possible on a classical computer, and there has been progress in the experimental development of quantum computers using a variety of architectures. Small devices based on trapped-ions or superconducting systems are now available with a clear roadmap to large-scale implementation.

There are known methods of finding the ground state energy of a physical system using a quantum computer. For example, the folded spectrum method is a method for solving eigenvalue problems. The method involves using an estimate for the target eigenvalue, λ, and minimising a shifted Hamiltonian (H−λI)². The function will have as its lowest eigenvector the true eigenvector provided the initial estimate of the target eigenvalue is sufficiently accurate. However, the folded spectrum method requires a large number of additional samples compared to finding the ground state since it requires calculating an PP term. This method also requires an accurate initial estimate of the desired state, and this method is not able to systematically find degenerate states, since this method distinguishes states based upon their energies.

A linear response methodology called the Quantum Subspace Expansion method has been proposed as an alternative possible solution. However, it requires additional sampling and introduces a new approximation. A different method has been proposed that minimises the von Neumann entropy to find excited states, however it requires implementing complicated controlled unitary gates that are difficult to implement on a quantum computer and require a quantum computer with a large coherence time. Accordingly, these methods are not practicable on modern quantum computers.

Prior methods are not efficient, and cannot find excited state energies (and their degenerate states) in a systematic manner.

The present invention seeks to address these and other disadvantages of known methods by providing an improved method of determining an energy level of a physical system using a quantum computer.

### SUMMARY

Aspects of the invention are set out in the independent claims. Optional features are set out in the dependent claims.

According to an aspect, a method for determining an unknown energy level of a physical system using a quantum computer is provided. The physical system can be in any one of a plurality of eigenstates, each respective eigenstate of the physical system having a corresponding energy level. The method comprises performing an iterative optimisation procedure. Each iteration of the optimisation procedure comprises preparing a first ansatz trial state using a first arrangement of quantum gates, the first ansatz trial state having a first state energy which is dependent on a trial state variable; performing an energy estimation routine to determine and output a value associated with an estimate for the first ansatz trial state energy; performing an overlap estimation routine to determine and output a degree of overlap between a first prepared state corresponding with or based on the first ansatz trial state, and a second prepared state corresponding with or based on a known state; determining the value of an optimisation function based on the outputs of the energy estimation routine and the overlap estimation routine; and updating the trial state variable. The method further comprises performing iterations of the optimisation procedure until a stopping criterion is reached, and also comprises outputting an energy value for the unknown energy level.

According to another aspect, a computer readable medium is provided which comprises computer-executable instructions which, when executed by a processor, cause the processor to perform the method described above.

The disclosed methods are significantly more efficient than existing methods in part because they make use of information relating to the overlap between states. Incorporating an estimated degree of overlap between a trial state and a state which is representative of an already known state of the physical system provides the basis for a more efficient iterative method. Also, as the iterative method makes use of overlap information rather than purely making use of energy values as in prior methods, the present methods are able to systematically determine degenerate energy levels. The method is also beneficial because, as each previously unknown energy level is determined, a trial state variable is also determined which describes how the energy level can be constructed on a quantum computer. This information is valuable in a number of fields, and can be used to inform another round of the optimisation procedure in order to systematically find a plurality of unknown energy levels of a physical system in a systematic and efficient manner.

### FIGURES

Specific examples are now described, by way of example only, with reference to the drawings, in which:

FIG. 1 depicts a schematic of a method as known in the prior art;

FIG. 2 shows a schematic of a method according to examples of the present disclosure;

FIG. 3 depicts a flowchart of a method according to examples of the present disclosure;

FIG. 4 depicts a quantum circuit used in methods of the present disclosure;

FIG. 5 depicts a quantum circuit used in methods of the present disclosure;

FIG. 6 depicts an implementation of methods of the present disclosure on a quantum computer;

FIG. 7 depicts a quantum circuit used in methods of the present disclosure;

FIG. 8 depicts a quantum circuit used in methods of the present disclosure;

FIG. 9 depicts a quantum circuit used in methods of the present disclosure;

FIG. 10 depicts a quantum circuit used in methods of the present disclosure;

FIG. 11 is a computer architecture which may be used to perform the methods of the present invention.

FIG. 12 is a flowchart showing a method according to the present invention.

### DETAILED DESCRIPTION

This disclosure relates to quantum computing, and in particular to methods of determining an energy level of a physical system using a quantum computer. The energy values of physical systems can generally be described using the Schrödinger equation and via knowledge of the relevant Hamiltonian operator. Accordingly, the disclosure more broadly relates to determining an eigenvalue of a Hermitian operator, in particular the Hamiltonian energy operator, using a quantum computer.

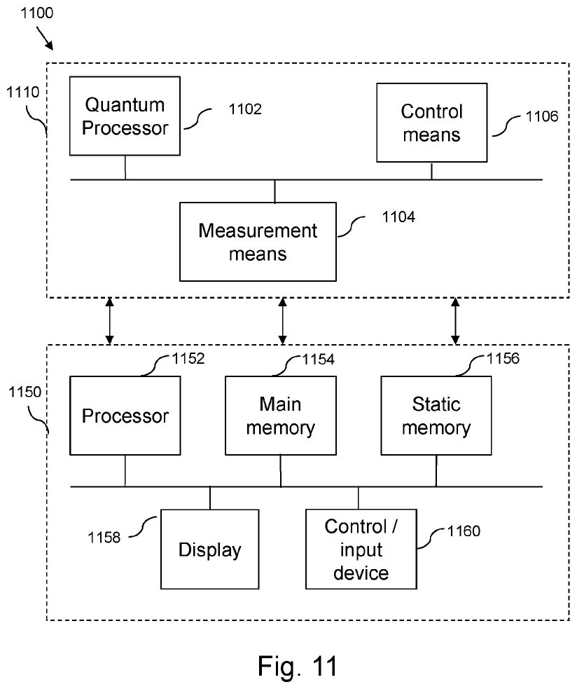

FIG. 11 illustrates a block diagram of one implementation of a computing device 1100 within which a set of instructions for causing the computing device to perform any one or more of the methodologies of the present disclosure may be executed. While only a single computing device is illustrated, the term “computing device” shall also be taken to include any collection of machines (e.g., computers) that individually or jointly execute a set (or multiple sets) of instructions to perform any one or more of the methodologies discussed herein. The computing device 1100 comprises a quantum computing system 1110 and a classical computing system 1150. The quantum computing system 1110 is in communication with classical computing system 1150. The classical computing system is arranged to instruct the quantum computing system to prepare quantum states, and to perform measurements on those quantum states, according to instructions stored in memory.

The quantum computing system 102 comprises a quantum processor 1102, which in turn comprises at least two qubits and at least one coupler capable of coupling the qubits. The qubits may be physically implemented using, for example, photons, trapped ions, electrons, one or more nuclei, superconductor circuits and/or quantum dots. In other words, a qubit may be be physically implemented in a variety of means, including the polarization state of a single photon; the spatial optical path of a single photon; two different eigenstates of an atom or an ion; the spin orientation of a particle or plurality of particles such as a nucleus. The quantum computer also comprises means for storing the qubits and maintaining the qubits in a suitable environment to allow quantum computation, for example means for supercooling the qubits. The qubits may be operated upon by one or more quantum circuits, formed by a suitable arrangement of quantum gates.

A quantum gate acts on some number of qubits and can be thought of as the quantum analogue of a basic low-level instruction in a classical circuit such as a NOT or AND gate. Typically, quantum circuits are decomposed into a sequence of single and two-qubit gates taken from a universal gate set along with state preparation and the measurement or read-out of the qubits. The results of the measurements are classical data that are then processed by a classical computer. Many quantum computers based on superconducting circuits and trapped-ions have already demonstrated all of the capabilities at a small scale that are required for a large quantum computing device.

Possible implementations and methods of manipulation of the qubits in the quantum computer are now described. These implementations are by way of example only, and the skilled person will be aware of other methods of implementing a quantum computer. Birefringent wave plates may be used to manipulate the polarization state of a single photon, for example, to cause a linear polarization or horizontal polarization of the photon, signifying two distinct states of the photon. The qubits may also be implemented using a beam splitter. For example, the presence or absence of a photon along particular optical path can be implemented using a beam splitter that splits a beam of photons into two separate paths. The presence of the photon in either path represents two distinct states of the photon. Alternatively or additionally, two separate electronic eigenstates for an atom or ion can represent two separate distinct states for a qubit. For example, transition energies between these levels may correspond to the energy of electromagnetic radiation of a certain frequency and so the separate eigenstates of the atom or ion may be addressed using a source of radiation such as a laser or microwave emitter. Alternatively or additionally, the two distinct spin states (spin “up” and spin “down”) of a particle or a plurality of particles, for example a nucleus, can represent the two distinct states of a qubit. Manipulations of nuclear spin may be implemented using a magnetic field using methods known to the person skilled in the art.

Alternatively or additionally, superconducting electronic circuits may be used to create qubits. These systems are typically supercooled to below 100 mK and use Josephson junctions, a non-linear inductor that allows the creation of anharmonic oscillators. Anharmonic oscillators do not have evenly spaced energy levels (unlike harmonic oscillators) and therefore two of the states can be separately controlled, and used to store a qubit. The qubits can be connected with microwave cavities and single and two-qubit gates can be performed using microwave signals.

The quantum computing device 1110 also comprises measurement means 1104 and control means 1106. The control means 1106 may comprise control hardware and/or a control device. The control means 1106 is configured to receive instructions from the classical computer 1150, and the classical computer 1150 may instruct the control means 1106 to prepare a particular state in the quantum processor using a particular arrangement of quantum gates. The measurement means 1104 may comprise measurement hardware and/or a measurement device. The measurement means comprises hardware configured to take a measurement from a state prepared by the control means 1106 in the quantum processor 1102.

The example classical computing device 1150 includes a processor 1152, a main memory 1154 (e.g., read-only memory (ROM), flash memory, dynamic random access memory (DRAM) such as synchronous DRAM (SDRAM) or Rambus DRAM (RDRAM), etc.), a static memory 1156 (e.g., flash memory, static random access memory (SRAM), etc.), and a secondary memory (e.g., a data storage device), which communicate with each other via a bus.

Processing device 1152 represents one or more general-purpose processors such as a microprocessor, central processing unit, or the like. More particularly, the processing device 1152 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1152 may also be one or more special-purpose processing devices such as an application specific integrated circuit (ASIC), a field programmable gate array (FPGA), a digital signal processor (DSP), network processor, or the like. Processing device 1152 is configured to execute the processing logic for performing the operations and steps discussed herein.

The data storage device may include one or more machine-readable storage media (or more specifically one or more non-transitory computer-readable storage media) on which is stored one or more sets of instructions embodying any one or more of the methodologies or functions described herein. The instructions may also reside, completely or at least partially, within the main memory 1154 and/or within the processing device 1152 during execution thereof by the computer system, the main memory 1154 and the processing device 1152 also constituting computer-readable storage media.

In general, the classical computer 1150 instructs the control means 1106 of the quantum computer 1110 to prepare a particular state in the quantum processor 1102. The control means 1106 manipulates the qubits in the quantum processor 1102 based on the instructions. Once the qubits have been manipulated such that the desired state has been constructed in the quantum processor 1102, the measurement means 1104 takes a measurement from the state. The quantum computer 1110 then communicates the measurement result to the classical computer.

The various methods described herein may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Standard VQE

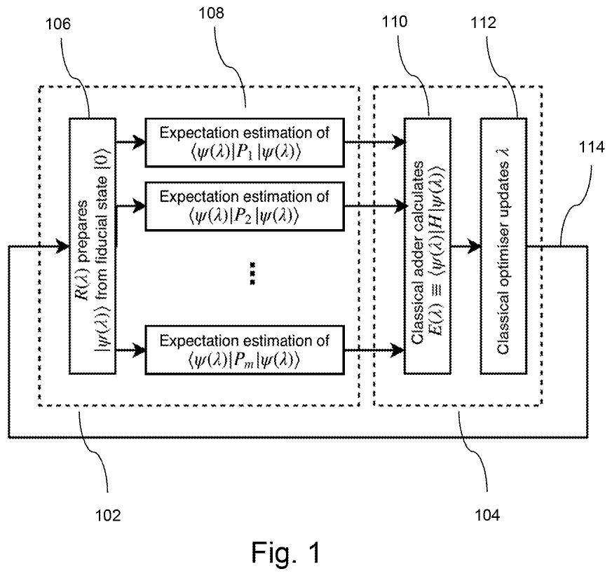

FIG. 1 depicts a known method of determining the ground state energy level of a physical system. The known method is referred to as the variational quantum eigensolver (VQE) approach. Dashed box 102 depicts those parts of the method which are performed using a quantum computer, using quantum circuits. Dashed box 104 depicts those parts of the method which are performed using a classical computer, using classical circuits. Arrows between dashed boxes 102 and 104 depict the interface between the quantum and classical computers.

As will be understood by the skilled person, the eigenstates and energies of a physical system may be described using a Hamiltonian operator. The standard VQE method can be used to determine the ground state energy of a Hamiltonian H of a physical system using a quantum expectation estimation sub-routine together with a classical optimizer. The classical optimizer adjusts the energy of variational ansatz wavefunctions |ψ(λ) [symbol] , depending on a parameter λ. For a given normalized |ψ(λ)>, it is possible to evaluate the energy:

E(λ)≡ [symbol] ψ(λ)|H|ψ(λ) [symbol] =Σαᵢ [symbol] ψ(λ)|Pₗ|ψ(λ)

[symbol]

To describe the standard VQE in more detail, the idea is to first write the Hamiltonian operator, H, as a finite sum H=ΣαᵢPᵢ where αᵢ are complex coefficients and Pᵢ are tensored Pauli matrices. The set of Pauli matrices forms a basis for the space in which H belongs. Each αᵢPᵢ can be described as a summand. The number m of summands is assumed to be polynomial in the size of the system as is the case for the electronic Hamiltonian of quantum chemistry.

To evaluate the eigenstate of the physical system, knowledge of the Hamiltonian is used to determine an ansatz trial state. This ansatz trial state has an energy E(λ), dependent on a parameter λ. The trial state is prepared in the quantum processor, and quantum circuits 102 are used to determine the expectation values of each summand. Given the expectation value estimates, a classical computer 104 is used to determine the weighted sum. This summation produces an estimate and/or a determination of the trial state energy. Finally, an optimiser such as classical Nelder-Mead is used to optimise the function E(λ) with respect to λ by controlling a preparation circuit:

R(λ):|0 [symbol] →|ψ(λ)

[symbol]

where |0 [symbol] is a fiducial starting state. Other types of optimizer may be used that are implemented on a classical or quantum computer. The variational principle (VP) justifies the entire VQE procedure when finding the ground state: writing Eₘᵢₙ for the ground state eigenvalue of H, VP states that EGO E(λ)≥Eₘᵢₙ with equality if and only if |ψ(λ)> is the ground state. Similarly, local minima may be representative of other energy levels/eigenstates of the physical system.

In the typical VQE process, a preparation circuit, R, comprised within the quantum computer is used to prepare an initial trial state |ψ(λ) [symbol] . The preparation of the initial trial state is shown at box 106 of FIG. 1.

The expectation value of each term in the Hamiltonian can then be estimated for the given trial state. This determination is shown at blocks 108 of FIG. 1. In other words, to determine an energy eigenvalue of a Hamiltonian with m summands, the quantum computing device measures: [symbol] ψ(λ)|P₁|ψ(λ) [symbol] ; [symbol] ψ(λ)|P₂|ψ(λ) [symbol] ; . . . [symbol] ψ(λ)|Pₘ|ψ(λ) [symbol] for the trial state.

These expectation values are communicated to a classical computing device, depicted by dashed box 104 in FIG. 1. The classical computing device sums the summands together to find the energy eigenvalue of the Hamiltonian for the initial trial state. Based on this eigenvalue, the classical computer 104 updates the parameter A at box 112, which allows the constructions of a new trial state. The quantum computer is instructed to prepare the new trial state, and the whole process is repeated until an optimisation procedure is satisfied that the desired energy level has been determined to the specified accuracy.

As will be understood by the skilled person, each expectation [symbol] ψ(λ)|Pᵢ|ω(λ) [symbol] may be directly measured using a simple circuit, or could be measured by using an extra work qubit and a c−Pᵢ gate, which can be implemented by a small circuit involving single qubit gates and c−NOT gates. In both cases, the circuit involved is of D=O(1) depth and is repeated N=O(1/ε²) times to attain precision within ε of the expectation. Herein, the regime wherein N=O(1/ε²), D=O(1) is referred to as the statistical sampling regime.

Note that the quantum-over-classical advantage is hidden within the set of ansatz states {|ψ(λ) [symbol] }_{λ}, chosen so that they could always be efficiently prepared on a quantum computer but not usually on a classical computer. The set of Unitary Coupled Cluster (UCC) states is a typical choice and could not usually be efficiently prepared classically due to the non-truncation of the Baker-Campbell-Hausdorff expansion of an operator of form e^{T-T}^{^{†}}. Other possible choices exist, such as the device ansatz and adiabatic state preparation ansatz.

Importantly, in standard VQE as depicted in FIG. 1, the summands in each of the boxes at 108 are determined using statistical sampling. In other words, the same, simple quantum circuit of depth D=O(1) is operated on the trial state a plurality of times, each time giving a different measurement outcome which is used to populate a single distribution. Operating the same quantum circuit on the trial state many times gives statistical accuracy in the measurement of the summand, however the number of required repetitions is often unfeasibly large, since the required number of repetitions N=O(1/ε²), scales quadratically with required accuracy ε.

### Variational Quantum Deflation Algorithm

Disclosed methods improve upon the Variational Quantum Eigensolver algorithm (VQE) in order to calculate an unknown energy level of a physical system, wherein the physical system can be in any one of a plurality of eigenstates with a corresponding energy level. At least one key difference is the introduction of performing an overlap estimation routine to determine and output a degree of overlap between a first prepared state corresponding with or based on the first ansatz state, and a second prepared state corresponding with or based on a known state. Using knowledge of the overlap between the trial state (or a state based on the trial state) and a known state, for example a known state having an energy which corresponds with at least one known energy level of the physical system has never been incorporated into this type of method before. Eigenstates of the physical system should be orthogonal to each other. It is possible to use knowledge of the relationship between the trial state and the already known state, e.g. knowledge of their overlap, to inform an iterative method. In an example, a function based on the degree of overlap between the trial state and the known state is minimised. In a further example, a function based on the degree of overlap between the trial state and each of the plurality of known states is minimised. The trial state which results in this function being minimised is orthogonal to each of the already known states of the physical system, which in turn implies that the trial state correctly corresponds with the unknown energy level of interest of the physical system.

The trial state variable is a description of how to recreate a state of the physical system on a quantum computer. By determining the unknown energy level along with the trial state variable which gives rise to the unknown energy level on the quantum computer, this information can be used to inform a determination of another unknown energy level which has another, unknown corresponding trial state. Thus, by determining not only the unknown energy levels of the physical system but also a corresponding trial state variable for each level, each energy level can be determined in a systematic manner on the quantum computer. The present method will now be discussed in detail.

The plurality of eigenstates and corresponding energy levels of the physical system can be described by a Hamiltonian H. In VQE, the trial state variables λ for the ansatz state |ψ(λ) [symbol] are classically optimised with respect to the expectation value:

$$E ( λ ) = 〈 ψ ( λ ) \vert H \vert ψ ( λ ) 〉 = {\sum }_{j} {α}_{j} 〈 ψ ( λ ) \vert {P}_{j} \vert ψ ( λ ) 〉$$

of the Hamiltonian H=ΣcⱼPⱼ computed using a low depth quantum circuit. As a result of the variational principle, finding the global minimum of E(λ) is equivalent to finding the best approximation to the ground state energy with the form of the ansatz and choice of basis.

A method is disclosed that extends VQE to calculate an unknown k^{th} state of a physical system by optimising the trial state variable λₖ for an ansatz state |ψ(λₖ) [symbol] such that an optimisation function:

$$F ( {λ}_{k} ) = 〈 ψ ( {λ}_{k} ) \vert H \vert ψ ( {λ}_{k} ) 〉 + {\sum }_{i = 0}^{k - 1} {β}_{i} \vert 〈 ψ ( {λ}_{i} ) \vert ψ ( {λ}_{k} ) 〉 {\vert}^{2}$$

is optimised, where βᵢ is a weighting term. By choosing sufficiently large γ₀βₖ₋₁, the minimum of F(λₖ) is the unknown energy of the kth state. This may be seen as minimising E(λₖ) subject to the constraint that |ψ(λₖ) [symbol] is orthogonal to the states |ψ(λ₀) [symbol] . . . |ψ(λₖ₋₁) [symbol] . Whilst the first term in the question for F(λₖ) is E(λₖ), and may be computed using the same quantum circuits as used for VQE, the second term is a sum of overlaps of the ansatz state with each of the known states 0 to k−1, wherein each of the known states have a corresponding known energy level.

The overlap between the ansatz state and each of the known eigenstates can be computed efficiently on a quantum computer.

The known states may already be known or may be determined using an iterative procedure.

In one example, λ₀ is determined using standard VQE methods. In another example, λ₀ may already be known, or may be determined using other methods.

In one example, λ₁ may already be known. In another example, λ₁ is determined by minimising the optimisation function F(λₖ) for k=1 using methods of the present disclosure.

In one example, λ₂ may be determined using the same procedure with the known λ₀ and λ₁, and so on until λₖ is determined. In another example. λ₀ . . . λₖ₋₁ are already known.

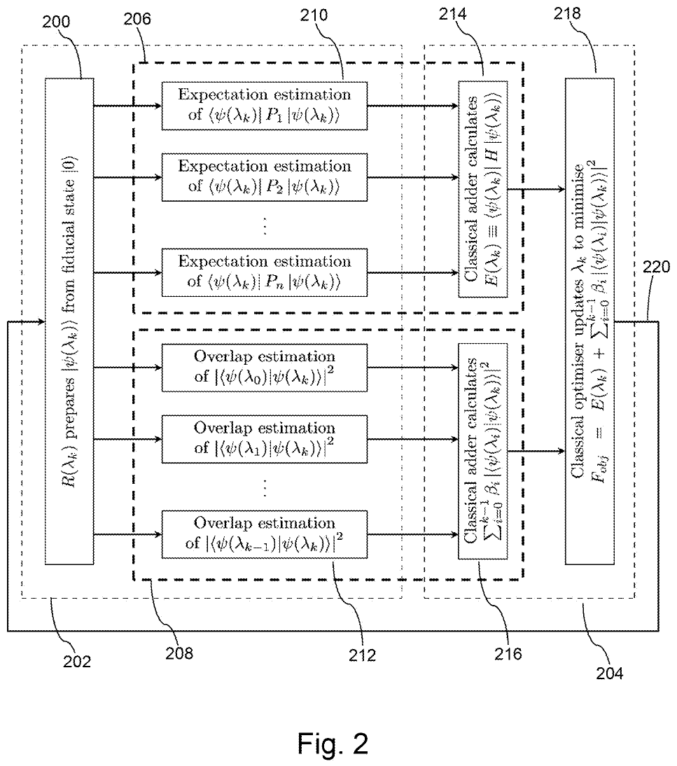

FIG. 2 shows a schematic of a method according to the present disclosure. Dashed box 202 depicts those parts of the method which are performed using a quantum computer, using quantum circuits. Dashed box 204 depicts those parts of the method which are performed using a classical computer, using classical circuits. Arrows between dashed boxes 202 and 204 depict the interface between the quantum and classical computers. Some or all parts of the method may be performed on the classical computer may also be performed on a quantum computer.

An initial estimate of the trial state variable λₖ is used at box 200 to generate a state preparation circuit R(λₖ) on a quantum computer that prepares the trial state |ψ(λₖ) [symbol] when applied to the fiducial state |0 [symbol] of the qubits of the quantum computer. The state preparation circuit can be realised using a suitable arrangement of quantum gates. The preparation of the trial state can be represented as:

R(λₖ)|0 [symbol] →|ψ(λₖ)

[symbol]

An energy estimation routine is depicted by dashed box 206. The energy estimation routine comprises estimating each of the expectation values [symbol] ψ(λₖ)|Pⱼ|ψ(λₖ) [symbol] at blocks 210. An expectation value is estimated for each Pauli matrix. This determination is similar or identical to the determination used in standard VQE, as discussed above. At box 214, the energy estimation routine 206 comprises estimating the energy of the trial state |ψ(λₖ) [symbol] by summing together each of the estimated expectation values from blocks 210.

It will be appreciated that, while determining expectation values and summing them together to find an estimate of the state energy has been described, it is also possible to introduce variations within the estimation routine. Terms in the summation for the energy computation may be re-arranged. For example, one of the expectation value estimations at blocks 210 may be omitted from the determination of the energy at step 214, and simply added to the cost function at block 218. In such an example where the expectation value of the nth Pauli matrix is omitted from the energy determination at step 214, the value determined at step 214 is not strictly an estimate for the energy of the trial state. It is however nonetheless a value indicative of, or associated with, an estimate for the first ansatz trial state energy. Accordingly, it will be appreciated that the energy estimation routine 206 may be described as a routine which determines and outputs a value equal to, indicative of, or associated with, an estimate for the first ansatz trial state energy.

An overlap estimation routine is depicted by dashed box 208. The overlap estimation routine is configured and designed to determine and output a degree of overlap between a first prepared state and a second prepared state. The first prepared corresponds with (e.g. is equal to), or is based on the first ansatz state. The second prepared state corresponds with, or is based on, a known state. In other words, a state is prepared in the quantum computer which is representative of an eigenstate of the physical system. The overlap estimation routine comprises estimating the overlap terms | [symbol] ψ(λᵢ)|ψ(λₖ) [symbol] |² at blocks 212. Each of these terms can be described as determining a degree of overlap between the trial state |ψ(λₖ) [symbol] and a known state |ψ(λᵢ) [symbol] , e.g. the ground state |ψ(λ₀) [symbol] . If the states are orthogonal to one another, the degree of overlap will be zero, or will be minimised. This can be used in order to determine whether the trial state |ψ(λₖ) [symbol] is a good approximation to the ‘true’ state of the physical system. Each block at 212 represents determining a degree of overlap between the trial state |ψ(λₖ) [symbol] and a state prepared on the quantum computer which represents, or is based on, a known eigenstate of the physical system. Each state |ψ(λᵢ) is prepared using a respective trial state variable for that state λᵢ. In other words, a particular state can be prepared on the quantum computer which represents a particular state of the physical system. The particular state can be prepared using a corresponding particular trial state variable. A degree of overlap between the particular state, which represents or is based on a known state of the physical system, and the trial state can be determined. Further, a degree of overlap can be determined for each of a plurality of known states, up until the k-lth state (i.e. the state just below the state of interest). The resulting values can be summed at box 216 to produce an overall or ‘total’ overlap estimation.

Accordingly, at box 216, the overlap estimation routine 208 estimates/determines the weighted sum of overlaps of the trial state with the known eigenstates of the physical system.

The outputs of the energy estimation routine 206 and the overlap estimation routine 208 may then be used calculate the optimisation function F(λₖ), e.g. a cost function, at box 218. The trial state variable λₖ is updated based on the value of the optimisation function. The optimisation function may be calculated using a classical computer. The optimisation function may be calculated using a quantum computer. The trial state variable may be updated at box 218 using a classical optimiser such as a gradient-free method such as Nelder-Mead or simulated annealing or other methods including gradient-based methods such as the Newton Conjugate Gradient method. The gradient of the optimisation function can be calculated using a classical computer using, for example, finite difference methods, or by using a quantum computer.

The method depicted in FIG. 2 may then be used again in an iterative manner using the updated trial state variable. The new trial state variable λₖ determined at box 218 may be fed back at arrow 220 to be used to prepare a new ansatz trial state on the quantum computer using a new state preparation circuit R(Aₖ) at box 200. The process may be iterated until a predetermined stopping criterion is reached.

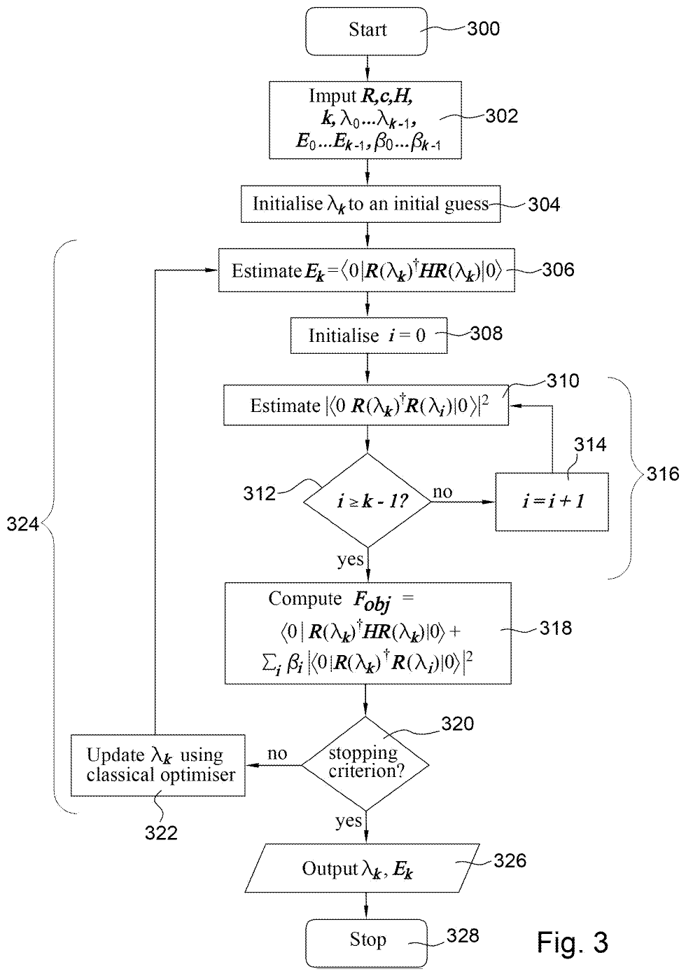

FIG. 3 shows a flowchart of a particular implementation of the schematic method depicted in FIG. 2.

At step 302, the following parameters are inputted into the method: the number of the unknown energy level k, the state variable A for each of the known eigenstates of the physical system, the energy levels E for the known eigenstates of the physical system, and weighting coefficients for weighting the sum of the overlaps in the overlap estimation routine.

At step 304, an initial guess for the trial state variable λₖ for the trial state |ψ(λₖ) [symbol] is made.

Also at step 304, the quantum computer generates a state preparation circuit R(λₖ) that prepares the trial state |ψ(λₖ) [symbol] when applied to the fiducial state |0 [symbol] of the qubits of the quantum computer.

At step 306, the energy estimation routine is performed to determine and output an estimate for trial state energy.

In more detail, the expectation value of the Hamiltonian describing the eigenstates and energies of the physical systems in the trial state |ψ(λₖ) [symbol] is estimated.

In yet more detail, the eigenstates and energies of the physical system may be described by the summation of a plurality of summands. The energy estimation routine estimates the expectation value of each summand in the trial state |ψ(λₖ) [symbol] , and sums the estimates for the expectation values of each summand in the trial state to estimate the trial state energy.

At step 310, the overlap estimation routine is performed to determine an estimate for the overlap between the trial state and a first known eigenstate of the physical system. At step 312, a test is performed to determine whether the overlaps between the trial state and all of the known eigenstates have been estimated by the overlap estimation routine. If the answer to the test 312 is no, then the overlap estimation method is performed to determine an estimate for the overlap between the trial state and a second known eigenstate of the physical system. Subroutine 316 is iterated to determine an estimate for the overlaps between the trial state and all of the known eigenstates.

At step 318, a value for the optimisation function is determined based on the output of the energy estimation routine 306 and the overlap estimation routine iterations performed in subroutine 316.

At step 320, a test is performed to determine whether a stopping criterion has been reached. The stopping criterion may take a number of forms, and may be predetermined or dynamically adjusted.

If the stopping criterion has not been reached, the trial state variable is updated using a classical optimiser. Subroutine 324 is then iterated using the updated trial state variable to determine an updated optimisation function. Subroutine 324 is repeated until the stopping criterion is reached.

When the stopping criterion is reached, step 326 outputs the trial state variable λₖ and the energy estimate determined at step 308 of the last iteration of the subroutine 324. The energy estimate Eₖ determined at step 308 of the last iteration of the subroutine 324 may represent the unknown energy level of the physical system.

Determining that the predetermined stopping criterion has been reached may comprise determining that a global minimum of the optimisation function F(λₖ) has been found. The trial state variable λₖ which results in the global minimum can be used to prepare a state which represents the state of interest on a quantum computer, and the output of the energy estimation routine at that λₖ comprises the energy of the state of interest. Accordingly, the unknown energy of the physical system Eₖ can be determined.

In another example, determining that the stopping criterion is reached may comprise finding a trial state variable which causes the optimisation function to satisfy F(λₖ)=Eₖ+O(ε), where E is a desired error in the energy determination. The stopping criterion may also be at least one of reaching a threshold number of iterations, where the threshold number of iterations is determined based on a desired accuracy in the determination of the unknown energy level. The stopping criterion may similarly comprise determining that a predetermined number of iterations during which the value of the optimisation function does not vary by over a threshold variation has been reached.

In another example, determining that the predetermined stopping criterion is reached may comprise determining that the optimisation function is minimised and corresponds to the unknown energy level of the physical system. The trial state λₖ that minimises the optimisation function represents to the unknown eigenstate corresponding to the unknown energy level of the physical system.

In another example, determining that the stopping criterion is reached may comprise determining that the optimisation function is maximised and corresponds to the unknown energy level of the physical system. The trial state λₖ that maximises the optimisation function represents to the unknown eigenstate corresponding to the unknown energy level of the physical system.

In another example, determining that the stopping criterion is reached may comprise finding a global minimum of the optimisation function and thus a determination that the corresponding parameters λₖ has been found.

In another example, the energy level of the physical system may be described by the summation of a plurality of summands. The energy estimation routine determines the expectation values of each summand in the trial state.

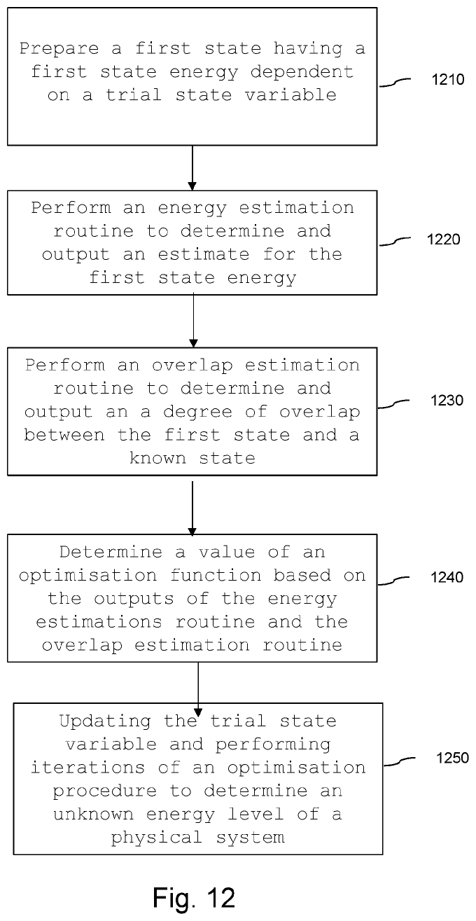

Reference is made to the flowchart of FIG. 12. One iteration of an optimisation procedure according to the method of the present disclosure is depicted in the flowchart of FIG. 12. At 1210, a first trial state is prepared. The first trial state has a trial state energy which is dependent on a trial state variable, λₖ. At 1220, an energy estimation routine is performed to determine and output an estimate for the first state energy. The energy level of the physical system may be described by the summation of a plurality of such summands. Hence, by determining an expectation value of each summand, the energy level, or state, of the physical system can be determined.

At 1230, an estimate for a degree of overlap between the first state and a known state is determined. The introduction of determining a degree of overlap between a first (trial) state and an already known state has never before been considered within the framework of VQE in this manner. Examples of how the estimate for the degree of overlap may be determined are described herein. More generally, this step may comprise performing an overlap estimation routine to determine and output a degree of overlap between a first prepared state corresponding with or based on the first ansatz state, and a second prepared state corresponding with or based on a known state.

At 1240, a value of an optimisation function F(λₖ) is determined based on the first state energy determined at 1220 and the degree of overlap determined at 1230.

At 1250, the unknown energy level of the physical system may be determined using, or according to, an optimisation procedure. The optimisation procedure updates the trial state variable in an iterative process and may comprise preparing and discarding quantum states, and the method may comprise performing steps 1210, 1220, 1230 and 1240 a plurality of times as will be described in greater detail herein.

In an example, the overlap estimation routine determines the overlap between the ansatz state and each of the known eigenstates using a SWAP test. In a preferred method, the SWAP test is the so-called ‘destructive SWAP test’.

The destructive SWAP test may be physically implemented using a quantum circuit as depicted in FIG. 5. The quantum circuit of FIG. 5 comprises operators H (500), R(λᵢ) (502), controlled-NOT (CNOT) gates (504), measurement operations (506) and classical processing (508) of the measurements. The skilled person would be aware that the quantum gate H (500) shown in FIG. 5 is a Hadamard gate which maps the basis state

$$\vert 0 〉 \to \frac{1}{\sqrt{( 2 )}} ( \vert 0 〉 + \vert 1 〉 ) and \vert 1 〉 \to \frac{1}{\sqrt{( 2 )}} ( \vert 0 〉 - \vert 1 〉 .$$

The quantum gate CNOT (504) maps the two-qubit basis state |00 [symbol] →|00 [symbol] and |01 [symbol] →|01 [symbol] and |10 [symbol] →|11 [symbol] and |11 [symbol] →|10 [symbol] . The n-qubit quantum gate R(λᵢ) (502) maps the fiducial state |0 [symbol] →|ψ(λᵢ) [symbol] where |ψ(λᵢ) [symbol] is a known state i which depends on the known state parameters λᵢ. The n-qubit quantum gate R(λₖ) (510) maps the fiducial state |0 [symbol] →|ψ(λₖ) [symbol] where |ψ(λₖ) [symbol] is the trial state k which depends on the trial state parameters λₖ. The skilled person would be aware that the classical operation mⁱ·m^{k} (mod 2) outputs 0 if the bitwise AND of the measurements of the first n qubits and the last n qubits has EVEN parity and 1 otherwise. The probability that the output of this classical operation is 0 is equa to

$$P = \frac{1 + \vert 〈 ψ ( {λ}_{k} ) \vert ψ ( {λ}_{i} 〉 {\vert}^{2}}{2} .$$

Therefore, by repeating the whole circuit many times, it is possible to estimate the overlap | [symbol] ψ(λₖ)|ψ(λᵢ)|².

In another embodiment, the overlap estimation routine determines the overlap between the ansatz state and each of the known eigenstates using a quantum phase estimation algorithm.

To calculate ω:= [symbol] ψ|P|ϕ [symbol] for any unitary P, the skilled person may perform quantum phase estimation (QPE) or α-QPE on the operator U₀ with input state |ψ [symbol] yielding b₀:=|ω| from the cosine of the phase, then on the operator U₁ with input state |+ψ) yielding b₁:=|1+ω|/2 from the cosine of the phase, then on the operator U₂ with input state |+ψ [symbol] yielding b₂:=|1−iω|/2 from the cosine of the phase. Then it is possible to find ω via Re(ω)=(4b₀²−b₀−1)/2 and Im(ω)=(4b₂²−b₀−1)/2. If instead it is desired to calculate [symbol] ψ|ϕ [symbol] we can use the same method but instead omit the unitary P or set P=I where I is the identity operator.

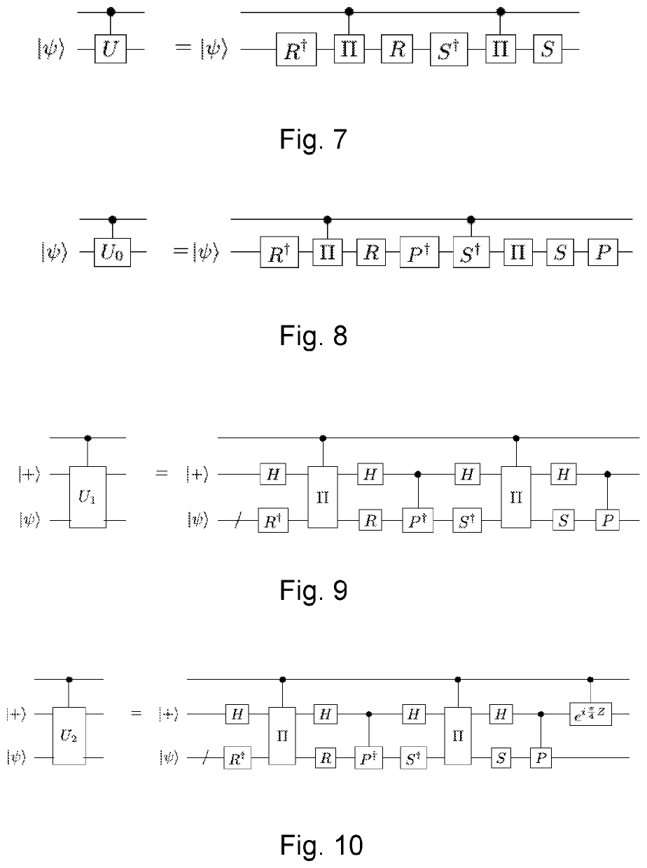

The quantum circuits of FIG. 7, 8, 9, 10 comprise operators P, S, R, and H. The skilled person would be aware that the quantum gate H is a Hadamard gate which maps the basis state

$$\vert 0 〉 \to \frac{1}{\sqrt{( 2 )}} ( \vert 0 〉 + \vert 1 〉 ) and \vert 1 〉 \to \frac{1}{\sqrt{( 2 )}} ( \vert 0 〉 - \vert 1 〉 .$$

The quantum gate P represents a summand for which the expectation value is to be determined/estimated, for example corresponding to a tensor product of Pauli operators. The quantum gate R represents the arrangement of quantum circuits that are used to prepare the state |ψ [symbol] . The quantum gate S represents the arrangement of quantum circuits that are used to prepare the state |ϕ [symbol] . The dagger notation refers to a Hermitian conjugate so that P^{†}, R^{†} and S^{†} refer to the quantum gates corresponding to the Hermitian conjugate of P, R and S respectively.

To calculate | [symbol] ψ|ϕ [symbol] |, the skilled person may perform quantum phase estimation (QPE) or α-QPE on the operator U with input state |ψ [symbol] yielding | [symbol] ψ|ϕ [symbol] | as depicted in FIG. 5. The value | [symbol] ψ|ϕ [symbol] | can be retrieved by taking the cosine of the angle measured using quantum phase estimation.

Methods of the present disclosure enable unknown eigenstates and energies of a physical system to be determined. Methods of the present disclosure systematically determine orthogonal eigenstates of a physical system, even if orthogonal eigenstates have the same corresponding energy. Therefore, methods of the present disclosure systematically determine degenerate eigenstates and their corresponding energies of a physical system.

These methods provide a distinct advantage over existing methods, since existing methods are unable to systematically find degenerate states because existing methods only distinguish eigenstates based upon their energies.

Knowing the degeneracy of each energy is useful in predicting behaviour of the physical system upon introducing external perturbation. For example, a state with a degeneracy N can split into N distinct states.

The term overlap used throughout should be understood to refer to the absolute value of the overlap between a known state and a trial state, or the complex overlap between a known state and a trial state.

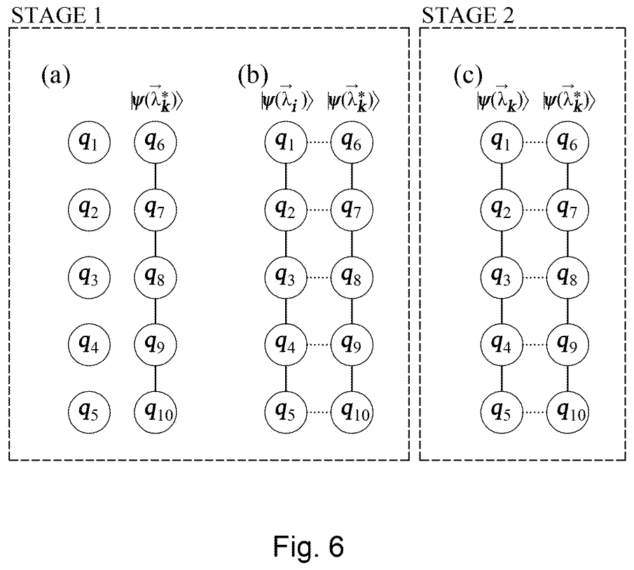

FIG. 6 depicts an implementation of the variational quantum deflation algorithm that requires a low coherence time to run on a quantum computer built using a rectangular nearest-neighbour grid architecture.

In present methods, a state can be created in a quantum computer which represents an eigenstate of a physical system. The state can be created according to a state variable λ. When the state, and its corresponding state variable, is unknown, methods of the present disclosure can be used to determine both the state and its state variable by adjusting a trial state variable to create a series of trial states. Optimising the trial state variable to find the state of interest is one of the subjects of the present application. However, while the state parameter λ is a description of how to create a particular state in the quantum computer, when a state is created using the state variable, errors may be introduced. The introduction of errors means that two states created using an identical trial variable may not necessarily entirely conform with one another, as particular qubits or quantum gates may have different errors.

Using the method described with reference to FIG. 6, overlap estimation techniques, for example the destructive swap test, can be used to shift parameters from one state to another. In other words, a particular state, for example a known state, in a first quantum register can be recreated in a second quantum register. For example, an arrangement of qubits in a first quantum register which represent a known state can be ‘copied’ onto another arrangement of qubits in a second quantum register. The methods described herein which can be used to determine a degree of overlap are used to ensure maximal overlap between a first state in a first quantum register and a second state in a second quantum register. When the overlap is maximised, the states are as identical to one another as possible, and hence the effect of control errors is mitigated or removed entirely.

Stage 1 of FIG. 6 shows how the optimisation function can be calculated using quantum circuits on a quantum computer with a rectangular nearest-neigbour grid architecture. Each circle in FIG. 6 represents a respective one of 10 qubits q₁ to q₁₀. The vertical lines between qubits q₆ to q₁₀ in Stage 1 (FIGS. 6a and 6b) depict an arrangement of quantum gates used to prepare the first ansatz trial state on a linear chain of qubits with nearest-neighbour connectivity. The vertical lines between qubits q₁ to q₅ in FIG. 6b depict an arrangement of quantum gates used to prepare a known state. The horizontal dotted lines in FIG. 6b depict an arrangement of quantum gates used to implement the destructive SWAP test of FIG. 5.

Stage 2 of FIG. 6 shows how the arrangement of quantum gates used to prepare a known state on qubits q₆ to q₁₀ can be optimised to prepare the same state on qubits q₁ to q₅ even if qubits q₁ to q₅ are imperfect and different to qubits q₆ to q₁₀. First the known state |ψ(λ*ₖ) [symbol] is prepared on qubits q₆ to q₁₀ (vertical lines between qubits q₆ to q₁₀ in FIG. 6c). Then, a new ansatz trial state |ψ(λ*ₖ) [symbol] is prepared on qubits q₁ to q₅. Then, the overlap | [symbol] ψ(λₖ)|ω(λ*ₖ) [symbol] |² of the known state with the new ansatz trial state is calculated using a destructive SWAP test (depicted with dotted lines in FIG. 6c). The new ansatz trial state parameters are then varied such that the cost function F₂=1−| [symbol] ψ(λ*ₖ)|ψ(λ*ₖ) [symbol] |² is minimised. After the global minimum of F₂ is found, the parameters of the new ansatz trial state allow the known state to be prepared on qubits q₁ to q₅. This Stage 2 is only necessary if qubits q₁ to q₅ and the gates that operate on them have different imperfections to qubits q₆ to q₁₀ and the gates that operate on them.

Whilst FIG. 6 depicts how variational quantum deflation can be implemented using N=5 qubits to represent a state on a ≥10-qubit quantum computer, a skilled person would be aware that the same approach can be generalised and used to find N-qubit states on a ≥2N qubit quantum computer.

This method of preparing a state is particularly useful in example implementations which seek to systematically find multiple energy levels of a physical system. For example, after the method of FIG. 2 has been performed and an energy determination of a particular state and its corresponding trial state have been outputted, the quantum computer will have the determined state created on an arrangement of qubits in a quantum register. When the method of FIG. 2 is to be performed again to find the ‘next’ energy level, then it is necessary to use the just determined state as part of the overlap estimation routine and as discussed elsewhere herein. In an example, the method depicted in FIG. 2 is used to determine an energy E(λₖ). It is then desired to determine the ‘next’ energy level. In this case, the determined λₖ becomes λₖ₋₁ and the corresponding state ψ(λₖ₋₁) is used as part of the overlap estimation routine.

As the previously determined state is already created in a register of the quantum computer, it is possible to use the knowledge of that state using the above-described method in order to accurately copy the state to another register for use in the overlap estimation routine.

In an example, it may be desirable to determine two different unknown energy levels. The energy levels may be successive energy levels, for example the first and second excited state of the physical system. The first unknown energy level is determined by performing a first round of the optimisation procedure depicted in FIG. 2 and described generally herein, and the second unknown energy level is determined by performing a second round of the optimisation procedure depicted in FIG. 2 and described generally herein.

In one example, the trial state variable which corresponds with the energy value for the first unknown energy level is then used to produce a known state for use in each iteration of the second round of the optimisation procedure.

Alternatively, and with reference to FIG. 6, the known state used in each iteration of the second round of the optimisation procedure is based on, or is representative of, the first eigenstate of interest, where the first unknown energy level corresponds with a first eigenstate of interest of the physical system. As explained above, the first eigenstate of interest may exist in a first quantum register of the quantum computer, and the second prepared state used in each iteration of the second round of the optimisation procedure is created by ‘copying’ the first eigenstate of interest into a second quantum register of the quantum computer. ‘Copying’ need not imply that the states are fully identical, but that they are almost identical or sufficiently similar to one another. In an example, ‘copying’ may simply mean that the overlap between the first eigenstate of interest and the newly created second prepared state is optimised, e.g. maximised. In other words, copying the first eigenstate of interest into a second quantum register of the quantum computer may comprise optimising a degree of overlap between the first eigenstate of interest and the qubits which comprise the second quantum register of the quantum computer.

### Weighting

In some methods, at least one of the energy estimation and the overlap estimation terms is weighted.

An equivalent viewpoint of the optimisation procedure is that the ground state of the effective Hamiltonian at stage k is found:

$${H}_{k} : = H + {\sum }_{i = 0}^{k - 1} {β}_{i} \vert i 〉 〈 i \vert$$

Where |i [symbol] is the i-th eigenstate of H with energy [symbol] |H|i [symbol] . It follows that for an arbitrary state |ψ [symbol] :=Σαᵢ|i [symbol] :

$$〈 ψ \vert {H}_{k} \vert ψ 〉 = {\sum }_{i = 0}^{k - 1} \vert {α}_{i} {\vert}^{2} ( {E}_{i} + {β}_{i} ) + {\sum }_{i = k}^{d - 1} \vert {α}_{i} {\vert}^{2} {E}_{i}$$

where d is the total number of eigenvectors of H.

Therefore, to guarantee a minimum at Eₖ, it suffices to choose βᵢ>Eₖ−Eᵢ. Since Δ:=E_{d-1}−E₀≥Eₖ−Eᵢ, it suffices to possess an accurate estimate of Δ, e.g. by using VQE to find E₀ and then E_{d-1} (using the Hamiltonian −H to find the latter). When H=Σ cⱼPⱼ as a linear combination of Pauli matrices, e.g. when H is the electronic structure Hamiltonian, then the upper bound Δ≤2∥H∥≤2Σ |cⱼ| is given. In this case, βᵢ may be chosen to guarantee the validity of our optimisation procedure.

Choosing valid βᵢ may be self-correcting. If A is incorrectly chose as βᵢ=F−Eᵢ<Eₖ−Eᵢ for all i, it may be found that βᵢ is set too small since a minimum at F(λ̅ₖ̅)=F=Eᵢ+βᵢ<Eₖ will be found. However, if the algorithm is repeated with a larger F until success (doubling each time, say), then a large enough F is found after only O(log(Eₖ)) runs of the algorithm.

### Alternative Effective Hamiltonians

Methods may be employed to find eigenvalues and eigenvectors of positive semi-definite matrices, e.g. covariance matrices in the context of PCA, starting from the largest eigenvalues.

To make direct use all deflation methods for positive semi-definite matrices, note that the Hamiltonian H₀:=−H+E′ for some E′≥E_{d-1}, e.g. E′=∥H∥, is positive semi-definite.

Other deflation methods exist such as projection deflation or Schur complement deflation which are designed to address the problem of not obtaining true eigen-states at each stage. These two methods, ensure that the true ground state of the effective Hamiltonian at each stage does not overlap with the previously found eigenstate estimates irrespective their accuracy.

For example, in projection deflation, the effective Hamiltonian at stage k is defined as:

$${H}_{k} = {A}_{k}^{†} ( H - {E}^{′} ) {A}_{k} \\ where : \\ {A}_{k} := {\prod }_{i = 0}^{k - 1} ( 1 - \vert i 〉 〈 i \vert ) \approx 1 - {\sum }_{i = 0}^{k - 1} \vert i 〉 〈 i \vert ,$$

and the last approximation holds when the previously found eigenvectors |i> are truly orthogonal.

With this approximation, writing H again as a linear combination of Pauli matrices Pⱼ, the value of <ψ|Hₖ|ψ> for an ansatz |ψ> is a linear combination of terms of forms: <ψ|Pⱼ|ψ>, |<ψ|i>|²<ψ|i>, <ψ|Pⱼ|i>, <i|Pⱼ|l> (for i, l<k). Without this approximation, the <μl> needs calculating. The important point now is that these additional terms can still be calculated using quantum circuits. Explicitly, to calculate ω:=<ψ|P|ϕ> for any unitary P, quantum phase estimation may be performed on the operators U₀, U₁ and U₂ with input state |ψ>, |+ψ>, |+ψ> as depicted in FIGS. 8, 9, 10 respectively. These respectively yield the values: b₀:=|ω|, b₁:=|1+ω|/2 and b₂:=|1−iω|/2. Then it is possible to find ω via Re(ω)=(4b₁²−b₀−1)/2 and Im(ω)=(4b₂²−b₀−1)/2.

### Low-Depth Implementation: Destructive Swap Test

The SWAP test enables the overlap |<ϕ|ψ>|² of two states |ψ> and |ϕ> to be determined to precision c using O(1/ε²) repeated measurements after applying a circuit to a quantum register in the state |ψ>⊗|ϕ>.

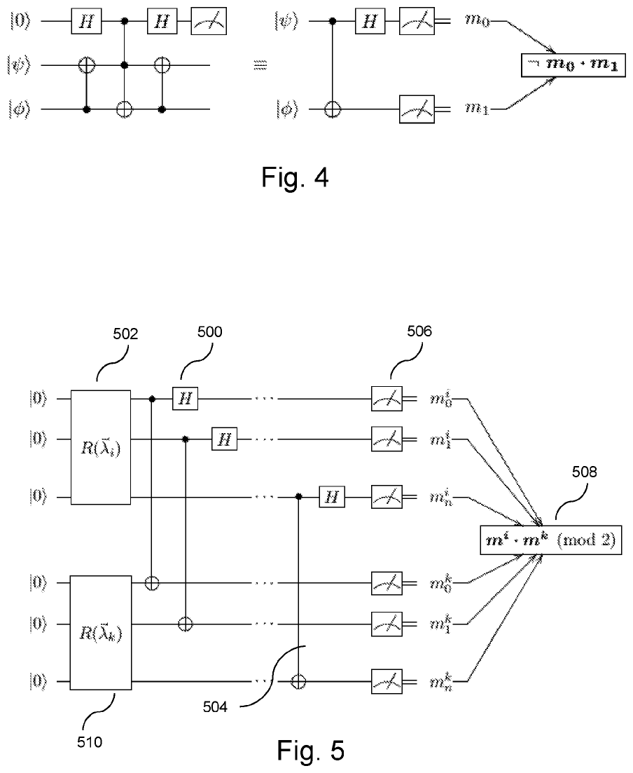

Whilst the original SWAP test required a SWAP gate controlled on an ancilla, the same outcome can be accomplished without an ancilla, using a Bell-basis measurement and classical logic. As can be seen in FIG. 4 for single qubit states, the original SWAP test (left) requires an ancilla, a toffoli, two CNOT gates and two Hadamard gates, whereas the equivalent so-called destructive SWAP test of FIG. 4 (right) merely requires one CNOT, one Hadamard and no ancillas. The destructive SWAP test can also be extended to 17-qubit states, using n parallel bell-basis measurements (see FIG. 5), achieving significant savings compared to the original SWAP test applied to n-qubits.

The probability that the SWAP test outputs 0 (‘passing’ the test) is

$${P}_{0} = \frac{1 + \vert < ϕ \vert ψ > {\vert}^{2}}{2}$$

Therefore, measuring a 1 (‘failing’ the test) guarantees that the states are different, whereas passing the test does not guarantee that they are equal. From the binomial distribution, an estimate of |<ϕ|ψ>|² can be calculated to precision ε with at most

$$\frac{1}{16 {ɛ}^{2}}$$

repetitions of the SWAP test.

Since the destructive SWAP test has an extremely low circuit depth, it is very simple to implement on current quantum computers.

An example of a low-depth implementation of the algorithm on a 10-qubit nearest-neighbour rectangular grid architecture is illustrated in FIG. 6. In the first stage of the algorithm, qubits q₆, q₇ . . . q₁₀ are used to prepare a 5-qubit trial ansatz state |ψ(\vec{λ}ₖ)> (see FIG. 6 part (a)). This can be done using any ansatz that can be implemented using a low-depth circuit on a linear chain of qubits with nearest neighbour connectivity (e.g. parameterised adiabatic state preparation using the fermionic SWAP network Trotter step. The energy of this state is then calculated using low-depth circuits and repeated measurements, as typically done in VQE. Next, each of the k−1 known previously-computed eigenstates |ψ(\vec{λ}ᵢ)> is prepared on qubits q₁, q₂ . . . q₅ and its overlap with |ψ(\vec{λ}ₖ)> is computed through repeated sampling of the destructive SWAP test, which can be implemented natively on the device in a depth-one circuit (illustrated in FIG. 6 part (b)). These steps (‘Stage 1’ in FIG. 6) are repeated for each iteration of the classical optimiser until the global minimum of the optimisation function F(λₖ) is reached.

In ‘Stage 2’ (see FIG. 6 part (c)), |ψ(\vec{λ}ₖ)> is again prepared on qubits q₆, q₇ . . . q₁₀ but this time with the (optimum) parameters \vec{λ}ₖ fixed. A new trial state |ψ(\vec{λ}*ₖ)> is then prepared on qubits q₂ . . . q₅ (initialised with \vec{λ}*ₖ=\vec{λ}ₖ). The trial state is then optimised subject to the cost function

F₂=1−|<ψ(\vec{λ}*ₖ)|ψ(\vec{λ}ₖ)>|²

in order to maximise the overlap between |ψ(\vec{λ}*ₖ)> and |ψ(\vec{λ}*ₖ)>. This essentially ‘copies’ the desired kth state onto qubits q₁, q² . . . q⁵ ready to be used to find the (k+1)st state, in a way that is resilient to differences in the coherent control errors between qubits q₁, q₂ . . . q₅ and q₆, q₇ . . . q₁₀. If it is known that all qubits are identical then this Stage 2 is unnecessary, and one can simply use \vec{λ*}ₖ=\vec{λ}ₖ.

This method can clearly be extended to larger systems such that the excited states of N-qubit systems can be computed using a N×2 nearest-neighbour grid quantum computer architecture with a depth-one circuit that is isomorphic to the architecture (i.e. no routing of quantum information required).

### Variable-Depth Implementation

Using overlap estimation instead of the SWAP test, the sampling cost can be reduced to O(log 1/ε), and only n+1 qubits are required. Overlap estimation calculates an overlap |<ϕ|ψ> by performing iterative phase estimation on the operator U depicted in FIG. 7. However, the circuit depth is increased to O(1/ε).

In Bayesian phase estimation, the same precision may be attained but reduce the circuit depth D by taking more samples N. There exists a method that enables a possible tradeoff with N=O(1/ε^{2(1-α)}) and D=O(1/ε^{α}) in Ref. [5] where αε[0, 1] is a free parameter which can be chosen such that the corresponding circuit depth is feasible.

Reference is made herein to an energy level of a physical system. The physical system could be any of an atom, a molecule, a collection of atoms, protein, enzyme or part thereof, chemical or material such as a potential superconductor. In each case, the energy levels play a central role in elucidating the properties of the chemical structures and reactions and their calculation has many applications in materials design, the design of new pharmaceuticals, or the design of novel catalysts.

Many existing methods concentrate on determining the ground state properties of these systems, however the characterisation of excited state energies is also required in order to fully understand the nature of a number of physical processes.

Such processes include those related to charge and energy transfer, for example in photovoltaic materials, or various chemical reactions, such as those involving photodissociation, photoisomerisation and photosynthesis. Additionally, the interpretation of molecular spectra is aided in the accurate interpretation of excited energy levels, and has implications in atmospheric modelling and characterisation.

In molecular systems, the absorption of photons can drive a transition into an excited state which corresponds to a different electronic configuration. This can often introduce some instability to the system, and may activate previously inaccessible reaction pathways which can lead to the creation of chemical products, or to different molecular conformations.

These can lead to emergent properties which may be desirable, such as in the catalysis of required reaction products, or may produce adverse effects, for example the isomerisation of a potential drug candidate into a toxic configuration.

In crystalline systems, the ability to calculate excited states may aid in the better description of materials such as photovoltaics, and improve the efficiency of their design.

In any case, the understanding of these reaction processes require a good description of the energy spectrum of the system.

The high level of accuracy that results from the methods disclosed herein enables the calculation of the energy differences which define such electronic excitations, leading to a refined understanding of existing chemical reaction processes that may be harnessed under controlled conditions, and to the synthesis of materials with desirable properties.

The methods disclosed herein are designed to best exploit the available capability of current and near-term quantum computing hardware. Primarily current and near-term hardware is limited by the maximum achievable coherence time on the device—in terms of quantum circuits this equates to a limit on the length of the circuit that can run without the effects of noise on the device distorting the results of the computation.

Until the presently disclosed method, existing methods for calculating an unknown energy level of a physical system were unable to accommodate the short circuit depth limitations of near-term quantum hardware. One method known in the art, the “WAVES” protocol makes use of a quantum subroutine known as the Iterative Phase Estimation Algorithm (IPEA) which requires the use of a large number of high-depth controlled gates. The “WAVES” protocol therefore requires a very large circuit depth which will not be achievable on near-term quantum hardware.

In sharp contrast to the methods known in the art, the method presented here employs a process called “overlap estimation” that can be achieved using low-depth circuits. In one implementation, the overlap estimation circuit requires the same number of qubits as standard low-depth VQE circuits, and at most twice the circuit depth. An alternative uses twice as many qubits but the same circuit depth as standard VQE.

The design of methods of the present disclosure are therefore motivated by technical considerations of the internal functioning of a quantum computer. Specifically, in view of the constraints of modern day quantum computers, such as the maximum available circuit depth and coherence time, the present methods include processes such as the overlap estimation which can maximally exploit the coherence time of the low-depth circuits available in modern day quantum computers. The methods of the present disclosure are therefore specially designed make optimal use of modern day quantum computing hardware to accurately determine an unknown energy level of a physical system.

In methods of the present disclosure, the physical system may also be artificially designed to encode very large real world data-sets. In this case, the eigenstates of a physical system (which methods of the present disclosure find) correspond exactly to the principal components of the data-set resulting from principal component analysis (PCA). Knowledge of the principal components allows a dramatic reduction in the dimensionality of the data-set which finds application in portfolio allocation, machine learning, image processing and data compression.

The approaches described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

Disclosed herein is a method for determining an unknown energy level of a physical system using a quantum computer, wherein the physical system can take one of a plurality of energy levels including the unknown energy level and at least one known energy level, the method comprising iteratively updating a trial state variable based on a value of an optimisation function. Each iteration of the optimisation procedure comprises preparing an ansatz trial state using an ansatz trial state preparation circuit comprising a first arrangement of quantum gates, the ansatz trial state having a trial state energy dependent on the trial state variable, determining an estimate for the trial state energy, and performing an overlap estimation routine to determine a degree of overlap between the ansatz trial state and at least one known eigenstate corresponding to a respective at least one known energy level. The overlap estimation method may comprise preparing the known eigenstate using a second arrangement of quantum gates and operating on the ansatz trial state and the at least one known eigenstate using an overlap circuit, and determining the value of an optimisation function corresponding to the ansatz trial state based on the estimate for the trial state energy and the output of the overlap estimation routine.

The method may further comprise determining the unknown energy level corresponding to an optimal value of the optimization function that corresponds to an optimal ansatz trial state.

It will be understood that the above description of specific embodiments is by way of example only and is not intended to limit the scope of the present disclosure. Many modifications of the described embodiments, are envisaged and intended to be within the scope of the present disclosure.

The above implementations have been described by way of example only, and the described implementations and arrangements are to be considered in all respects only as illustrative and not restrictive. It will be appreciated that variations of the described implementations and arrangements may be made without departing from the scope of the invention.

While reference has been made throughout to eigenstates of a physical system, it should be understood that an eigenstate of the system is related to and in some cases equivalent to an energy state of the system, depending on preferred terminology.

While reference has been made throughout to eigenstates of a physical system, it should be understood that the disclosed methods can be applied to any eigenvalue problem and any optimisation problem. It should be understood that the energy of an eigenstate of a physical system may correspond to a cost function of an optimization problem.

1. A method for determining at least one unknown energy level of a physical system using a quantum computer, wherein the physical system can be in any one of a plurality of eigenstates, each respective eigenstate of the physical system having a corresponding energy level, the method comprising performing an iterative optimisation procedure, wherein each iteration of the optimisation procedure comprises:
preparing a first ansatz trial state using a first arrangement of quantum gates, the first ansatz trial state having a first state energy which is dependent on a trial state variable,
performing an energy estimation routine to determine and output a value associated with an estimate for the first ansatz trial state energy;
performing an overlap estimation routine to determine and output a degree of overlap between a first prepared state corresponding with or based on the first ansatz trial state, and a second prepared state corresponding with or based on a known state;
determining the value of an optimisation function based on the outputs of the energy estimation routine and the overlap estimation routine; and
updating the trial state variable;
the method further comprising performing iterations of the optimisation procedure until a stopping criterion is reached, and outputting a value for the at least one unknown energy level.

2. The method of claim 1, wherein the trial state variable is updated according to the optimisation procedure, and optionally wherein the trial state variable is updated based on the determined value of the optimisation function.

3. The method of claim 1, wherein the known state represents a known state of the physical system, and optionally wherein the known state has an energy which corresponds with at least one known energy level of the physical system.

4. The method of claim 1, wherein the stopping criterion is based on a desired accuracy in the determination of the at least one unknown energy level.

5. The method of claim 1, further comprising determining that the stopping criterion has been reached, wherein determining that the stopping criterion has been reached comprises at least one of:
determining that a desired accuracy in the determination of the at least one unknown energy level has been reached;
determining that a threshold number of iterations has been reached, the threshold number of iterations being determined based on a desired accuracy in the determination of the at least one unknown energy level; and
determining that a predetermined number of iterations after which the value of the optimisation function does not vary by over a threshold variation has been reached.

6. The method of claim 1, wherein each respective energy level of the plurality of energy levels can be described by a respective summation of a plurality of summands, and wherein performing the energy estimation routine further comprises estimating an expectation value of each summand respectively for the first state and summing the expectation value estimates of each summand to determine the estimate for the first state energy.

7. The method of claim 1, further comprising outputting the trial state variable which corresponds with the energy value for the at least one unknown energy level.

8. The method of claim 1, the at least one unknown energy level comprising a first and a second unknown energy level; wherein the first unknown energy level is determined by performing a first round of the optimisation procedure and the second unknown energy level is determined by performing a second round of the optimisation procedure.

9. The method of claim 8 wherein the trial state variable which corresponds with the energy value for the first unknown energy level is used to produce a known state for use in each iteration of the second round of the optimisation procedure.

10. The method of claim 8, wherein the first unknown energy level corresponds with a first eigenstate of interest of the physical system, and the known state used in each iteration of the second round of the optimisation procedure is based on, or is representative of, the first eigenstate of interest.

11. The method of claim 10, wherein the first eigenstate of interest exists in a first quantum register of the quantum computer, and the second prepared state used in each iteration of the second round of the optimisation procedure is created by copying the first eigenstate of interest into a second quantum register of the quantum computer.

12. The method of claim 11, wherein copying the first eigenstate of interest into a second quantum register of the quantum computer comprises optimising a degree of overlap between the first eigenstate of interest and the qubits which comprise the second quantum register of the quantum computer.

13. The method of claim 12, wherein optimising the degree of overlap comprises maximising the degree of overlap.

14. The method of claim 1, wherein the overlap estimation routine comprises preparing the known state; and determining a degree of overlap between the trial state and second states.

15. The method of claim 1, wherein determining the degree of overlap comprises performing a SWAP test, optionally wherein the SWAP test is a destructive SWAP test.

16. The method of claim 1, wherein the overlap estimation routine further comprises determining a degree of overlap between the first prepared state and each of a plurality of known states, each known state corresponding with or based on a respective known state of the physical system.

17. The method of claim 16, wherein the output of the overlap estimation routine is a summation of each respective degree of overlap between the first prepared state and each of the known eigenstates.

18. The method of claim 1, wherein determining the value of the optimisation function comprises summing the output of the energy estimation routine and the output of the overlap estimation routine.

19. The method of claim 1, wherein the known energy level represents the ground state energy level of the physical system.

20. A computer readable medium comprising computer-executable instructions which, when executed by a processor, cause the processor to perform the method of claim 1.
